(19) United States
(12) Patent Application Publication
(10) Pub. No.: US 2026/0253009 A1
(43) Pub. Date: Aug. 27, 2026

(54) SYSTEM AND METHOD FOR ANALYZING CUSTOMER INTERACTIONS

(71) Applicant: Amitesh Sinha, Ashburn, VA (US)

(72) Inventor: Amitesh Sinha, Ashburn, VA (US)

(21) Appl. No.: 19/059,400

(22) Filed: Feb. 21, 2025

(51) Int. Cl. G06Q 10/0637; G06F 40/30; G06Q 10/0639

(52) U.S. Cl. CPC G06Q 10/0637; G06F 40/30; G06Q 10/06393; G06Q 10/06395

(57) ABSTRACT

The invention discloses a system for analyzing customer interactions. The system comprises an interaction data acquisition component to acquire interaction data from several communication mediums which include voice, e-mail and chat. The information undergoes natural language processing to deduce the feelings of customers and their speaking mannerisms. The result of the processing is then passed to a next level that is the machine learning module to check for more patterns that will show a service blind spot. Therefore, a recommendation system to deliver training recommendations for the service staff based on an evaluation is disclosed. In the disclosed invention, interactions are reported on a real-time reporting dashboard plus other performance metrics as part of the interaction analysis. This system enhances the quality of customer services because information from different interfaces is gathered and analyzed for specific recommendations for enhancing the services.

### FIELD OF THE INVENTION

The present invention focuses on leveraging advanced techniques in artificial intelligence and customer service technology. Specifically, it involves a system and method for analysing customer interactions using advanced machine learning and natural language processing (NLP) algorithms. The invention provides actionable insights and dynamic recommendations to improve service delivery, optimize customer experiences, and enhance staff training in various communication channels, such as phone, email, and chat.

### BACKGROUND OF THE INVENTION

Customer service is one of the most critical components of modern business operations, directly impacting customer satisfaction, retention, and brand loyalty. With the growth of communication platforms such as email, chat, and phone calls, businesses have faced increasing challenges in monitoring, analyzing, and improving customer interactions at scale. Current methods of interaction evaluation, such as manual call sampling or scripted response tracking, are often labor-intensive, prone to human bias, and incapable of providing actionable, data-driven insights.

Several prior art solutions have been developed to address these issues, but each comes with its limitations. For instance, U.S. Pat. No. 9,100,482 describes a system that allows supervisors to monitor contact center agents through mobile devices, offering real-time performance data. While this solution provides valuable monitoring capabilities, it does not incorporate advanced natural language processing (NLP) or machine learning techniques to analyze conversational tone, sentiment, or context. Additionally, it does not offer tailored, actionable recommendations for improving individual staff performance.

Similarly, US Patent Application No. 20140143018A1 discusses predictive modeling using customer interaction data to forecast outcomes. However, this solution focuses primarily on future predictions rather than analyzing real-time interactions for actionable insights or suggesting improvements for customer service agents. U.S. Pat. No. 12,033,162B2 introduces a system for identifying customer intent and generating a hierarchy of customer issues from interaction data. While it captures textual insights effectively, it lacks a feedback loop or the capability to integrate interaction data from multiple platforms such as voice, chat, and email. Furthermore, U.S. Pat. No. 11,055,649B1 automates responses based on customer-agent interaction transcripts. However, this invention is geared toward automation rather than improving the skills of human customer service agents. It fails to provide recommendations or dynamic training interventions that are personalized to the specific needs of staff members.

Despite advancements in these prior technologies, existing systems have critical gaps. Many fail to analyze conversational nuances, such as empathy in tone or sentiment shifts during an interaction. Others lack a unified approach to analyzing data across multiple communication channels, preventing businesses from obtaining a holistic view of their customer service quality. Moreover, current systems do not offer mechanisms for continuous improvement, such as adaptive feedback loops that refine recommendations over time based on staff or manager input.

### SUMMARY OF THE INVENTION

To address the foregoing problems, in whole or in part, and/or other problems that may have been observed by persons skilled in the art, the present disclosure provides compositions and methods as described by way of example as set forth below.

An object of the invention is to introduce a coherent top level that identifies the customer conversation regardless of the channel (voice; email; chat), and evaluates the structural sentiment and tone, and interaction quality about a particular offering in real time using NLP and ML.

Another object of the invention is to create practical training solutions for the service staff in response to interaction analysis and for ensuring that the customers' needs are met by bringing out the deficiencies of every individual and enhancing his/her performance.

Another object of the invention is the purpose of integrating a reporting dashboard for tracking related and unrelated interaction statistics as well as establishing the overall performance trend, in addition to feedback loop system that will allow for the adjustment of the recommendation as per Manager and staff feedback.

In view of the foregoing, the present invention relates to a system for analyzing customer interactions, which includes a data collection module configured to aggregate interaction data from a plurality of communication platforms. The system further comprises a natural language processing (NLP) engine configured to process the interaction data to evaluate customer sentiment and conversational tone. Additionally, the system includes a machine learning analysis module configured to analyze the processed interaction data to identify patterns and trends indicative of service gaps. A recommendation system is provided to generate training suggestions for service staff based on the analysis. The system also features a reporting dashboard configured to present interaction analysis results and staff performance metrics. Collectively, these components enable the system to provide actionable insights in real-time, thereby improving customer service quality across the communication platforms.

In an aspect, the data collection module captures metadata associated with the customer interactions, including timestamps, customer identifiers, and session durations.

In an aspect, the natural language processing (NLP) engine comprises a sentiment analysis component configured to classify interactions as positive, neutral, or negative, and a tone analysis component configured to detect emotional cues such as empathy or frustration.

In an aspect, the machine learning analysis module detects anomalies in interaction data indicative of recurring customer complaints or service bottlenecks.

In an aspect, the recommendation system generates individualized training programs for service staff based on specific interaction metrics.

In another embodiment, the invention provides a method for analyzing customer interactions, which comprises aggregating interaction data from a plurality of communication platforms using a data collection module. The method further includes processing the interaction data using a natural language processing (NLP) engine to evaluate customer sentiment and conversational tone. Additionally, the processed interaction data is analyzed using a machine learning analysis module to identify patterns and trends indicative of service gaps. Based on the analysis performed by the machine learning analysis module, training suggestions for service staff are generated using a recommendation system. The method also involves presenting interaction analysis results and staff performance metrics on a reporting dashboard. Collectively, these steps enable the method to provide actionable insights in real-time, thereby improving customer service quality across the communication platforms.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates architecture of a system for analyzing customer interactions, in accordance with an embodiment of the present invention;

FIG. 2 illustrates workflow for analyzing customer interactions, in accordance with an embodiment of the present invention;

Skilled artisans will appreciate that the elements in the drawings are illustrated for clarity and simplicity, focusing on the functional aspects of the software design. The drawings emphasize components and workflows pertinent to understanding the embodiments of the present invention, omitting extraneous details that would be readily apparent to those of ordinary skill in the art.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present invention discloses an enhanced system which uses artificial intelligence to analyze customer interaction and enhance the quality of service as well as staff productivity. The interaction data of the customer service can be supplied from the telephone, email, chat and many other forms and integrated into the system for visualization. It applies sophisticated NLP/ML to analyse the customer emotion, interaction effectiveness, and staff's performance and provides the prescriptive and instant feedback.

The disclosed invention is an AI-powered system designed to analyze, interpret, and improve customer interactions across multiple communication platforms, such as voice, email, and chat. It uses a combination of advanced Natural Language Processing (NLP) techniques and Machine Learning (ML) algorithms to process data, generate actionable insights, and provide real-time recommendations for enhancing service quality and staff performance.

A core feature of the invention is its dynamic recommendation system, which generates actionable training interventions tailored to individual staff members based on real-time performance analysis. This system ensures targeted improvements in service delivery by addressing specific areas of need for each team member. The invention also incorporates a feedback loop, allowing managers and staff to refine and adapt the AI-generated recommendations over time, ensuring continuous learning and system evolution.

Additionally, the invention provides a reporting dashboard that visualizes key performance metrics, such as sentiment trends, interaction quality scores, and the effectiveness of training interventions. By offering a unified and intuitive interface, the dashboard enables managers to make informed decisions about staff training and service strategies.

Unlike prior solutions that focus on isolated communication channels or static performance metrics, this invention delivers a real-time analysis of customer interactions. It bridges the gap between data insights and actionable improvements, empowering organizations to enhance service quality, develop staff skills, and meet evolving customer expectations.

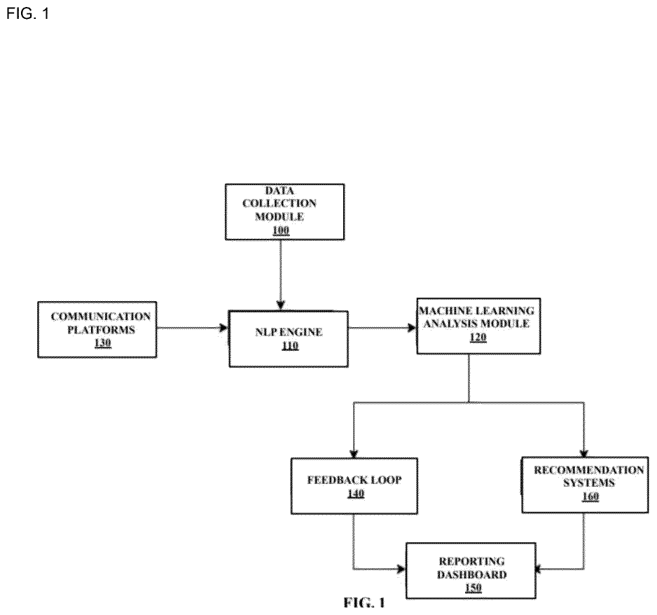

In accordance with an embodiment of the present invention, FIG. 1 illustrates architecture of a system for analyzing customer interactions. The architectural design of the customer interaction analyzer for service Improvement, as illustrated in FIG. 1, consists of interconnected modules that cohesively analyze customer interactions, extract meaningful insights, and provide actionable recommendations to enhance service quality and staff performance. This system incorporates six key components: the data collection module 100, the natural language processing (NLP) engine 110, the machine learning analysis module 120, the recommendation system 160, the feedback loop 140, and the reporting dashboard 150. Together, these components create a seamless workflow that processes raw interaction data from communication platforms 130, transforms it into structured insights, and delivers tailored solutions to improve customer service.

The data collection module 100 serves as the entry point of the system, interfacing with diverse communication platforms 130, including telephony systems, email servers, and chat applications. This module aggregates raw interaction data, such as call recordings, email threads, and chat logs, along with metadata like timestamps, customer identifiers, and interaction durations. For instance, in a call center environment, the module captures audio files, whereas in email-based communications, it retrieves message exchanges. By integrating with multiple platforms, this module ensures comprehensive data coverage across all channels, creating a unified repository of customer interaction data for subsequent analysis. The aggregated data undergoes preprocessing to standardize its format and structure, ensuring compatibility with analytical modules. The NLP engine 110 processes this standardized data to extract valuable insights, such as customer sentiment, conversational tone, and contextual topics. It employs advanced algorithms to classify interactions as positive, neutral, or negative and detect emotional cues like empathy or frustration. This step enables the system to identify subtle conversational nuances and evaluate the overall quality of customer interactions.

Following NLP analysis, the machine learning analysis module 120 identifies patterns, trends, and anomalies in the processed data. This module detects recurring service issues, such as common customer complaints, and predicts future interaction trends, such as increased inquiries during peak sales seasons. By providing predictive analytics, this module enables businesses to proactively address potential challenges and optimize future interactions.

The insights derived from the machine learning module 120 are utilized by the recommendation system 160 to generate actionable training suggestions. These recommendations are tailored to address specific needs, such as improving technical troubleshooting skills or enhancing chatbot scripts to handle frequently asked questions more effectively. The recommendations can be applied at both individual agent and organizational levels, ensuring targeted improvements in service delivery.

The feedback loop 140 incorporates input from managers and staff to continuously refine the recommendations generated by the system. For example, managers can review the effectiveness of a proposed training initiative and provide feedback for further adjustments. This dynamic feedback mechanism ensures the system remains adaptable and responsive to evolving business requirements over time.

Finally, the reporting dashboard 150 consolidates all findings into an intuitive interface that visualizes performance metrics, sentiment trends, and the effectiveness of implemented recommendations. Managers can use this dashboard to make informed decisions and monitor the progress of customer service initiatives. For example, the dashboard may display a reduction in negative sentiment over time, demonstrating the impact of a recent training program.

FIG. 1 highlights the modular and scalable architecture of the system, which allows for seamless integration into existing workflows and adaptability across industries. By addressing complex customer interaction challenges across multiple platforms, the system provides a comprehensive and efficient solution for improving service quality and operational efficiency.

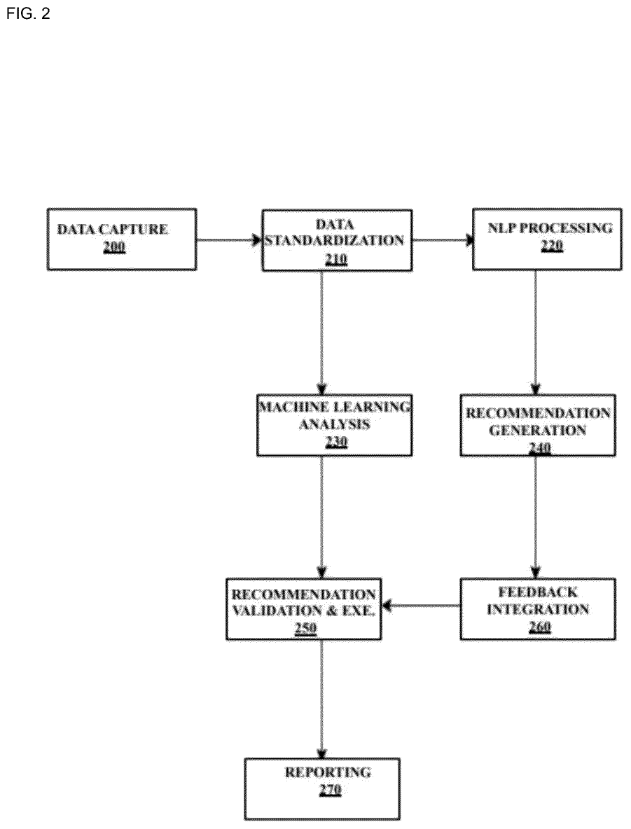

In accordance with an embodiment of the present invention FIG. 2 illustrates workflow for analyzing customer interactions. The workflow for analyzing customer interactions, as illustrated in FIG. 2, outlines a sequential process involving multiple interconnected stages, each contributing to transforming raw interaction data into actionable insights. This workflow is designed to comprehensively process customer interaction data from collection to actionable recommendations, ensuring a streamlined and effective system for improving service quality and staff performance. The process begins with data capture 200, where interaction data is collected from various communication platforms, such as voice calls, emails, and chat communications. For voice calls, recordings are transcribed using speech-to-text algorithms, while chat and email data are directly ingested as text files. To ensure traceability, metadata such as timestamps, customer identifiers, and session durations is also captured during this stage, creating a robust dataset for further analysis.

Once the data is collected, it undergoes a data standardization process 210. During this stage, inconsistencies in the format, language, or structure of the data are resolved to ensure compatibility across analytical modules. For instance, transcription errors in call recordings are corrected, fragmented chat logs are reconstructed to preserve conversational context, and redundant or irrelevant data is removed. This cleaning and structuring step is essential to prepare the data for accurate analysis.

The standardized data is then processed by the natural language processing (NLP) engine in the NLP processing stage 220. The NLP engine evaluates the data to extract insights such as customer sentiment, conversational tone, and discussion topics. Sentiment analysis classifies interactions as positive, neutral, or negative, while tone analysis detects emotional cues like empathy or frustration. Topic recognition identifies the primary subject of the interaction, such as refund policies or technical support, providing a deeper understanding of customer concerns and needs.

The processed data is further analyzed in the machine learning analysis stage 230. This module identifies patterns, trends, and anomalies within the data. For example, it may detect recurring service issues, such as frequent complaints about delayed responses, or highlight seasonal trends in customer feedback, such as increased inquiries during promotional periods. Predictive analytics within this module enable businesses to anticipate future customer behavior and prepare accordingly, enhancing their responsiveness and efficiency.

The insights generated by the machine learning analysis module are translated into actionable recommendations during the recommendation generation stage 240. These recommendations are tailored to address specific needs, such as scheduling targeted training sessions, updating chatbot scripts, or refining customer communication strategies. Recommendations can be tailored to individual agents or applied to broader organizational processes, ensuring relevance and practicality. The recommendations are subsequently reviewed and executed during the recommendation validation and execution stage 250. Managers evaluate the system-suggested recommendations to ensure their feasibility and relevance. For instance, a manager may implement a training session for conflict resolution based on a recommendation or adjust the suggestion to better suit team-specific requirements.

In the feedback integration stage 260, input from managers and staff is incorporated into the system to refine future recommendations. This dynamic feedback mechanism ensures continuous system evolution, improving the accuracy and relevance of recommendations over time. By adapting to user feedback, the system remains responsive to changing business needs and priorities.

Finally, the reporting stage 270 consolidates all findings into an intuitive reporting dashboard. This dashboard presents performance metrics, sentiment trends, and the outcomes of implemented recommendations, allowing managers to monitor progress and assess the system's impact. For example, the dashboard may display a reduction in negative sentiment over time, demonstrating the success of recent initiatives.

FIG. 2 highlights a well-structured and adaptable workflow that enables the system to process raw customer interaction data, extract meaningful insights, and generate actionable solutions, making it a comprehensive tool for enhancing customer service quality and operational efficiency.

Some of the non-limiting advantages of the present invention are:
Comprehensive Data Analysis Across Channels: The system gathers information on multipleg interfaces (voice, e-mail, chat) what means that the system give the full picture of customer service quality what is impossible to gain when using traditional system.
Real-Time Actionable Insights: As it is based on NLP and ML, the system provides responses within minutes rather than days, allowing for quicker reaction to emerging service deficiencies and customer complaints.
Personalized Training Interventions: Separate recommendations for certain employers enhance their staff members' results and compensate for their inefficiency, thus promoting skill development.
Continuous improvement through feedback loops: The integrated feedback also allows the managers or the staff to modify the content AI will generate to suit organizational needs thereby making the invention dynamic.
Enhanced Decision-Making with intuitive Dashboards: There appear interacting-quality and sentiment reports, which present important percentages and tendencies that a manager can easily consider while making effective decisions with a helping of the reporting dashboard.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in the discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A system for analyzing customer interactions, the system comprising:
a data collection module configured to aggregate interaction data from a plurality of communication platforms;
a natural language processing (NLP) engine configured to process the interaction data to evaluate customer sentiment and conversational tone;
a machine learning analysis module configured to analyze the processed interaction data to identify patterns and trends indicative of service gaps;
a recommendation system configured to generate training suggestions for service staff based on the analysis; and
a reporting dashboard configured to present interaction analysis results and staff performance metrics, wherein the system provides actionable insights in real-time to improve customer service quality across the communication platforms.

2. The system of claim 1, wherein the data collection module captures metadata associated with the customer interactions, including timestamps, customer identifiers, and session durations.

3. The system of claim 1, wherein the natural language processing (NLP) engine comprises a sentiment analysis component configured to classify interactions as positive, neutral, or negative, and a tone analysis component configured to detect emotional cues such as empathy or frustration.

4. The system of claim 1, wherein the machine learning analysis module detects anomalies in interaction data indicative of recurring customer complaints or service bottlenecks.

5. The system of claim 1, wherein the recommendation system generates individualized training programs for service staff based on specific interaction metrics.

6. The system of claim 1, further comprising a feedback loop configured to incorporate input from service staff and managers to refine the recommendations generated by the recommendation system.

7. The system of claim 1, wherein the reporting dashboard provides visualizations of sentiment trends and the effectiveness of implemented training recommendations.

8. The system of claim 1, wherein the data collection module integrates with telephony systems, email servers, and chat platforms to aggregate interaction data across diverse communication channels.

9. The system of claim 1, wherein the recommendation system dynamically adjusts predefined training modules stored in a memory based on the analysis results.

10. The system of claim 1, wherein the system is implemented on a cloud-based infrastructure to ensure scalability and accessibility across multiple business locations.

11. A method for analyzing customer interactions, the method comprising:
aggregating interaction data from a plurality of communication platforms using a data collection module;
processing the interaction data using a natural language processing (NLP) engine to evaluate customer sentiment and conversational tone;
analyzing the processed interaction data using a machine learning analysis module to identify patterns and trends indicative of service gaps;
generating training suggestions for service staff based on the analysis performed by the machine learning analysis module using a recommendation system; and
presenting interaction analysis results and staff performance metrics on a reporting dashboard, wherein the method provides actionable insights in real-time to improve customer service quality across the communication platforms.

12. The method of claim 1, wherein analyzing the processed interaction data further comprises detecting anomalies in the interaction data indicative of recurring customer complaints or service bottlenecks.

13. The method of claim 1, wherein generating training suggestions comprises creating individualized training programs for service staff based on specific interaction metrics.

14. The method of claim 1, further comprising incorporating input from service staff and managers into a feedback loop to refine the generated training suggestions.

15. The method of claim 1, wherein presenting the interaction analysis results further comprises visualizing sentiment trends and the effectiveness of implemented training suggestions.
